(19) United States
(12) Patent Application Publication
(10) Pub. No.: US 2006/0103300 A1
(43) Pub. Date: May 18, 2006

(54) Flexible displays

(76) Inventor: Michael A. Powell, London (GB)

Correspondence Address: SUTHERLAND ASBILL & BRENNAN LLP, 999 PEACHTREE STREET, N.E., ATLANTA, GA, 30309, US

(21) Appl. No.: 11/281,954

(22) Filed: Nov. 14, 2005

(30) Foreign Application Priority Data
Nov. 12, 2004 (GB) 0425034.6

(51) Int. Cl. H05B 33/00

(52) U.S. Cl. 313/511

(57) ABSTRACT

A flexible display (10) comprising a display, such as an electroluminescent (EL) panel, arranged to change appearance on application of an electric field; a display electrode (15) on a surface of the display shaped so as to define a display area; an insulating layer (16) covering the electrode; and a conducting track (17) provided on the insulating layer; in which at least one gap (16a) is provided in the insulating layer, the conducting track contacts the electrode through the or each gap and in which the or each gap is placed substantially outside a region of the display which is to be flexed. Furthermore, or alternatively, the conducting track may contact the electrode through the or each gap (16a) and cover substantially the entire area of the or each gap. The display may also or alternatively comprise a plurality of display electrodes on a surface of the display shaped so as to define a plurality of display areas; in which a plurality of gaps are provided in the insulating layer, the conducting track contacts the electrodes through the gaps, with the conducting track comprising a plurality of segments (60, 61) each contacting one electrode and contacting each other at one or more junctions, and in which the or each junction is not over a gap.

### TECHNICAL FIELD

The present invention relates to flexible displays, particularly but not exclusively relating to flexible printed displays such as Electroluminescent (EL) displays.

### BACKGROUND OF THE INVENTION

Electroluminescence is the emission of light from a substance under electric-field excitation. Phosphor electroluminescence was discovered and documented in 1936, but it was not until the 1950s that GTE Sylvania received a patent for an EL powder lamp. However, the short lifetimes (around 500 hours) of such devices limited their use. Work carried out in the 1980s revitalised the powder EL lamp and in 1990 the Durel Corporation demonstrated a flexible EL phosphor device that was incorporated into a LCD flat panel display as a backlight. The manufacturing technique involved encapsulating the phosphor powder particles in glass beads and sandwiching the powder, held in a dielectric matrix, between two electrodes. An AC voltage was applied to the electrodes to stimulate emission. In this way, the thick film phosphor lamp was made a commercial reality.

A typical, known phosphor EL device is shown in FIG. 1 of the accompanying drawings and comprises a light emitting material 3 in a dielectric matrix 5, sandwiched between two conducting electrodes 1, 6. The material comprises a light-emitting component (the “emitter”) being phosphor, typically a zinc sulphide (ZnS) powder doped with manganese (Mn). Typically, silver-(Ag) or graphite-loaded screen-printable inks and indium tin oxide (ITO), which is a transparent conductive material, are used as the electrodes 1, 6. When an AC voltage is applied between the electrodes the emitter breaks down and conducts current. The current excites the manganese ions, which give off light.

It is known to construct lamps from EL material. The benefits of phosphor EL lamps are that they can be made very thin (less than 0.3 mm); they are flat, fully flexible when applied to a flexible plastics substrate; they are rugged, have a wide viewing angle, can be made quite cheaply, can be made in low volumes using simple techniques, and give off very little heat when emitting light. Typically, EL lamps are used for backlighting LCD displays (for example, watches, mobile phones and so on) and instrument panels.

By shaping one of the electrodes, discrete areas of the EL material (herein “display areas”) can be made to emit light. This enables an EL material to be used in a display. Furthermore, as EL devices can be made to be flexible, switches can be placed on the underside of the display (that is, the non-illuminated side) such that pressing on an area of the EL display, typically denoted by an illuminatable area as described above, flexes the display such that the switch is activated.

Such a display can be seen in FIG. 2 of the accompanying drawings. This has the substrate 11, ITO electrode 12 and EL material 13 common to the lamp of FIG. 1. Typically, the display areas are formed by forming an insulating layer 14 having gaps 14a therein on the underside of the EL material 13 and forming a conductive electrode 15 over the gaps. The gaps in this insulating layer 14 define the shape of the display area.

A further insulating layer 16 is applied over the electrode 15; the further insulating layer 16 itself having gaps 16a. These gaps allow conductive tracks 17 to be laid over the further insulating layer 16, to contact the electrode and so supply it with the necessary AC signal. Current may therefore pass from the conducting tracks, though the “vias” 19 formed by the gaps in the further insulating layer to the electrode. In general, it is desired to keep the conductive tracks of as small an area as possible, in order to decrease the amount of conductive material used. The gaps are larger than the conductive tracks crossing them, such that errors in alignment of the conductive track relative to the gap are tolerated.

The conductive tracks can be used to supply a network of display areas which are to be illuminated together. Junctions over the gap of each display area allow the track to branch to travel to each area in turn. FIG. 3 of the accompanying drawings depicts schematically such a network that may be used on the numeric control panel of a domestic remote control; the number 1 to 9 are laid out in a 3×3 grid, with a central track 30 along the central column, and branches 31 out along each row from the central track.

It has been appreciated that, over repeated actuations of a switch through an EL display as described above, the light emitted by the EL display in that region diminishes. This is evidently undesirable. The problem is exacerbated if the repeated actuations are over a short timescale.

Whilst the problem has been appreciated by the applicant with regard to EL displays, it has application to any flexible display.

### SUMMARY OF THE INVENTION

According to a first aspect of the invention, we provide a flexible display comprising:

a display means arranged to change appearance on application of an electric field;
a display electrode on a surface of the display means shaped so as to define a display area;
an insulating layer covering the display electrode; and
a conducting track provided on the insulating layer;
   in which at least one gap is provided in the insulating layer, the conducting track contacts the display electrode through the or each gap and in which the or each gap is placed generally outside a region of the display which is to be flexed.

The applicant has appreciated that flexure of the conducting track in the gaps in the insulating layer—the so-called “vias”—increases the resistance of the conductive track. By avoiding flexing these areas, the increase in resistance can be avoided or at least reduced.

By flexed, we may mean any movement which deforms the region of the display out of a plane in which a remainder of the display lies. The movement may be in use, or may be during formation of the display.

The or each gap may be spaced along the surface of the display means from the centre of the display electrode. Preferably, the or each gap may be at the periphery of the display electrode, or outside the lit area thereof.

The display may be further provided with a switch operated by flexure of the display means around the display electrode, in which the or each gap is spaced along the surface of the display means from the centre of the switch. Preferably the or each gap is positioned at the periphery of the switch, or in an even more preferred embodiment, outside the region of the display flexed when the switch is operated.

Spacing the or each gap from the commonly-used positions will reduce the flexing of the “vias” due to a user pressing on the switch or the illuminated section corresponding to the display electrode.

The region to be flexed may be a non-planar region. The gaps may be outside this region. The non-planar section may be formed by subjecting the display to a strain force, generally at elevated temperature. The applicant has appreciated that avoiding having “vias” in this section avoids the undesirable increase in resistance.

According to a second aspect of the invention, we provide an electroluminescent display comprising:
a display means arranged to change appearance on application of an electric field;
a display electrode on a surface of the display means shaped so as to define a display area;
an insulating layer covering the display electrode; and
a conducting track provided on the insulating layer;
   in which at least one gap is provided in the insulating layer, wherein the conducting track contacts the display electrode through the or each gap and covers substantially the entire area of the or each gap.

Providing the conducting track over substantially the entirety of the or each gap has been shown to decrease the increase in resistance due to flexure of the “vias”. The connection is made over a greater area, and as such the effect over the whole is reduced. In a preferred embodiment, the conducting track covers the entirety of the gap in the insulating layer.

In a further refinement, the conducting track may extend further around the or each gap such that a path for current is provided that does not pass over the gap. This may be provided by providing a larger area of track than gap (so that current may pass around the outside of the gap). Alternatively, a bypass track may be provided which branches off the track on one side of the or each gap and rejoins on a second side of the or each gap without passing over the or each gap.

According to a third aspect of the invention, we provide an electroluminescent display comprising:
a display means arranged to change appearance on application of an electric field;
a plurality of display electrodes on a surface of the display means shaped so as to define a plurality of display areas;
an insulating layer covering the display electrodes; and
a conducting track provided on the insulating layer;
   in which a plurality of gaps are provided in the insulating layer, the conducting track contacts the display electrodes through the gaps, with the conducting track comprising a plurality of segments each contacting one display electrode and contacting each other at one or more junctions, and in which the or each junction is not over a gap.

This helps to ensure that any increase in resistance due to flexure of a via does not cause a loss of power to other display electrodes as would be the case where a junction over a gap feeds a plurality of display electrodes. This is the situation in the prior art, where such a branched network is a simple solution to providing a network of tracks to power a plurality of display electrodes.

Preferably, each segment terminates at a display electrode.

The display of any of the aspects of the invention may also fall within any other of the aspects. Indeed, each of the aspects of the invention may also be provided with any of the optional features of the other aspect. They may also have any of the following optional features.

The or each display electrode or the conducting track may be printed using conductive material with a resistivity of less than 0.5 Ω/square. The display may be manufactured so that the resistivity of the material does not vary significantly during manufacture of the display. The conductive material may be such that the resistance of the material does not vary significantly with aging due to the evolution of solvent from the conducting layer, or continuing chemical processes within the layer, such as cross linking of a binding matrix. The conductive material may be such that the resistance of the material does not vary significantly with deformations of the display that have a resultant radius of curvature of greater than 200 mm or correspond to an actuation force of between 1 g and 1 kg.

The display may be a printed display. Preferably, the display is an electroluminescent display. In such a case, the display means may be an electroluminescent material. Alternatively, the display may be a liquid crystal display, in which the display means may be a liquid crystal material. By display area, we mean a discrete section of the display that can be displayed or illuminated.

According to a fourth aspect of the invention, there is provided an electronic device comprising the display of any of the previous aspects and associated electronic circuits.

These and other features of the present invention will become apparent to one of ordinary skill in the art upon review of the following detailed description of the invention when taken in conjunction with the drawings and the appended claims.

### BRIEF DESCRIPTION OF THE DRAWINGS

There now follows, by way of example only, embodiments of the present invention described with reference to the accompanying drawings, in which:

FIG. 1 shows a prior art EL lamp;

FIG. 2 shows a cross section through a prior art EL display;

FIG. 3 shows a schematic view of a network of display areas according to the prior art;

FIG. 4 shows a plan view of an EL display according to the present invention;

FIGS. 5a and 5b show further alternative embodiments of the conductive track of the present invention; and

FIG. 6 shows a schematic plan view of a network of display areas according to the present invention.

### DETAILED DESCRIPTION

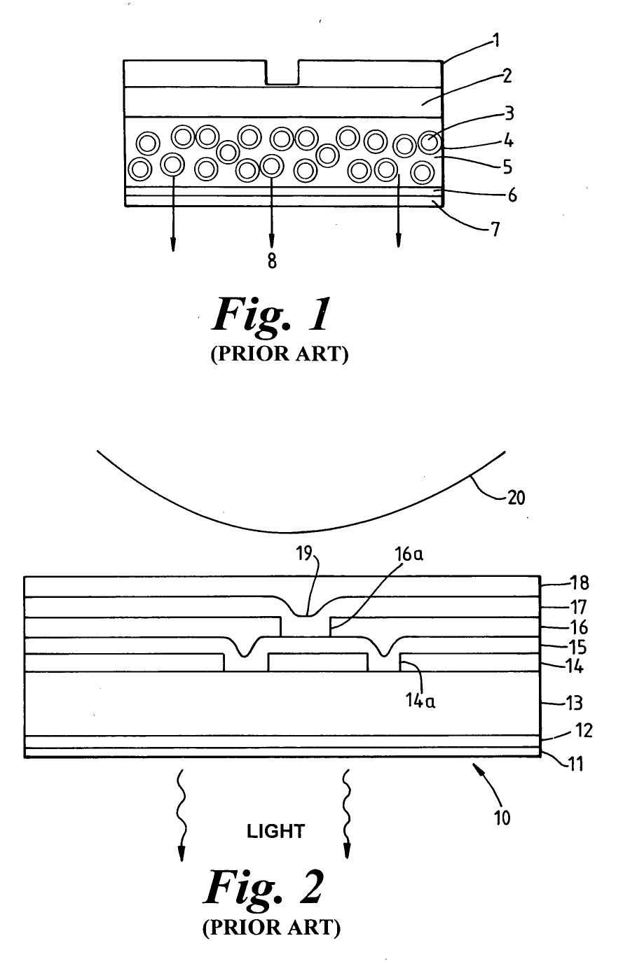

FIG. 1 shows a typical prior art EL lamp. The essential elements of the lamp are electroluminescent particles 3, such as phosphor, which are held between two electrodes 1,6. One of the electrodes is a transparent electrode 6, often of Indium Tin Oxide (ITO). The particles 3 may be encapsulated in glass or ITO beads 4 and held in a dielectric matrix 5, to form a display means. A further layer of dielectric 2 may be provided in order to avoid short-circuiting problems and the whole lamp is laid out on a substrate 7 of some sort, typically glass or plastics. When an electric field is present between the two electrodes 1, 6, the EL lamp emits light 8.

In the following, phosphor is used as an example of an electroluminescent material. The person skilled in the art will appreciate that many other substances may be used for the same purpose without departing from the invention.

The EL display shown in FIG. 4 of the accompanying drawings forms an EL display of the number “5”; this is merely an example and any suitable number, letter or other device can be displayed.

The layer structure of the display 10 of FIG. 4 is similar to that shown in FIG. 2 of the accompanying drawings, and can be understood with reference to that Figure. The positions of the features within the layers forms part of this invention, and is best seen in the plan view of FIG. 4 of the accompanying drawings. A clear substrate 11 forms a base for the display 10. On this is formed a clear first electrode 12 typically of Indium Tin Oxide (ITO). A layer of electroluminescent (EL) material 13 is formed on top of this as is known in the prior art. This forms the display means of the present invention.

On top of the EL layer 13 is formed an insulating layer 14. This has a series of gaps 14a which define the shape of the illuminated display area; in this example the gap 14a would be in the shape of the figure “5”. Over the insulating layer is printed (or otherwise formed) a display electrode 15, typically silver in a binder matrix. The display electrode 15 is arranged such that it covers the gap 14a and a wider area for convenient connection to the track discussed below.

On top of the second display electrode 15 is defined a further insulating layer 16 (corresponding to the insulating layer defined in the aspects of the invention), separating a conducting track (typically also printed as silver in a binding matrix) 17 on top of that layer from the display electrode 15. This insulating layer 16 also has gaps 16a therein to allow parts of the connecting track 17—known as “vias” 19—to connect to the display electrode 15. Electrical connection can then be made to the connecting track to a suitable power supply at a location remote to the display area.

A switch 20 can be provided on the underside—that is the side opposite the substrate 11 through which light will be emitted—which a user can press by flexing the display 10. This is shown schematically in FIG. 2 of the accompanying drawings.

The applicant has appreciated that flexure of vias 19 causes an increase in resistance of the via and as such should be avoided. Rather than place the via in the centre of the digit shown, it is spaced outwards, in this case to the bottom left of the figure “5”. This avoids the region of greatest flexure. Furthermore, rather than simply provide a track of constant width that passes over a section of the gap 16a in the further insulating layer 16, the conductive track 17 widens to cover the entire gap 16a. This increase in area reduces the overall effect of flexing of the vias 19.

Indeed, the widened section 17a also covers an area around the gap 16a. This provides a path for current to pass from one side of the gap to the other without passing through the via 19.

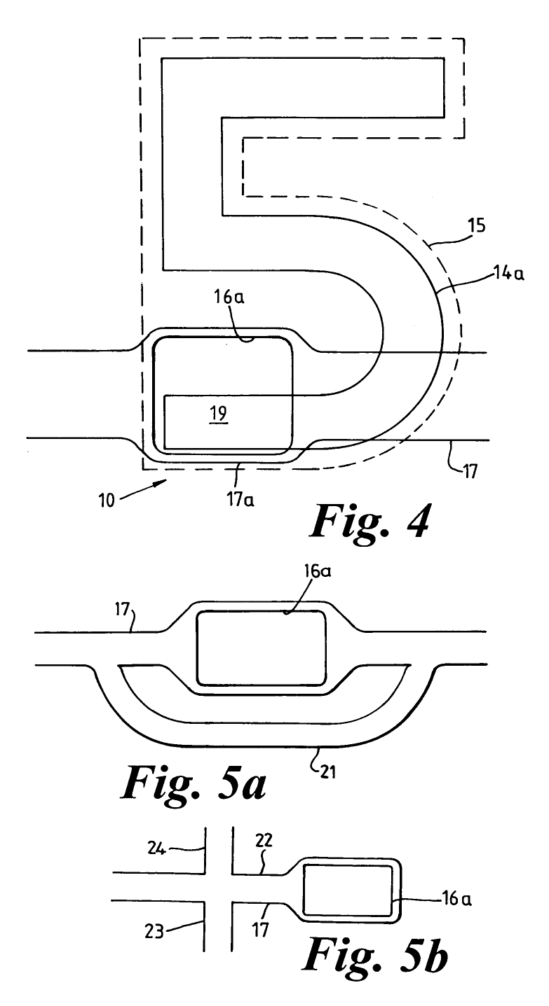

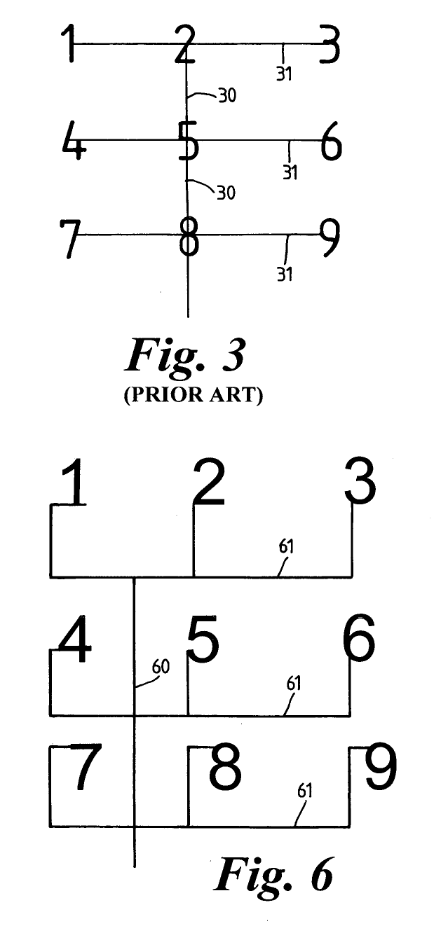

In an alternative shown in FIG. 5a of the accompanying drawings, the conductive track is provided with a separate bypass track 21 that splits from the conductive track 17 before it reaches the gap 16a and rejoins the conductive track on the other side of the track 17. In another alternative shown in FIG. 5b of the accompanying drawings, the conductive track 17 branches over an area that is not over the gap 16a; one branch 22 terminates over the gap 16a whilst others 23, 24 continue to the display electrodes of other display areas. In this example, the other display areas would be the digits remaining from 1 to 9 as shown in FIG. 6 of the accompanying drawings; the central track and branches are displaced from the prior art example of FIG. 3 of the accompanying drawings such that the junctions between central track 60 and branches 61 are not over any of the gaps 16a. Not forming junctions over the gaps ensures that any increase in resistance of the vias does not affect the power supplied to any other display electrode.

It should be apparent that the foregoing relates only to the preferred embodiments of the present invention and that numerous changes and modification may be made herein without departing from the general spirit and scope of the invention as defined by the following claims and the equivalents thereof.

1. A flexible display comprising:
a display arranged to change appearance on application of an electric field;
a display electrode on a surface of the display shaped so as to define a display area;
an insulating layer covering the display electrode; and
a conducting track provided on the insulating layer;
in which at least one gap is provided in the insulating layer, the conducting track contacts the electrode through the or each gap and in which the or each gap is placed substantially outside a region of the display which is to be flexed.

2. The display of claim 1, in which the or each gap is spaced along a surface of the display from a centre region of the display electrode.

3. The display of claim 2, in which the or each gap is at a periphery of the display electrode.

4. The display of claim 2, in which the or each gap is outside a lit area of the electrode.

5. The display of claim 1, further provided with a switch arranged to be operated by flexure of the display over the display electrode, in which the or each gap is spaced along the surface of the display from a centre of the switch.

6. The display of claim 5, in which the or each gap is positioned at an area overlying a periphery of the switch.

7. The display of claim 5, in which the gap is outside a region of the display which is flexed when the switch is operated.

8. The display of claim 7, in which the region to be flexed is a non-planar region of the display.

9. The display of claim 8, in which the or each gap is not in the non-planar region.

10. A flexible display comprising:
a display arranged to change appearance on application of an electric field;
a display electrode on a surface of the display shaped so as to define a display area;
an insulating layer covering the display electrode; and
a conducting track provided on the insulating layer;
in which at least one gap is provided in the insulating layer, wherein the conducting track contacts the display electrode through the or each gap and covers substantially the entire area of the or each gap.

11. The display of claim 10 in which the conducting track covers the entirety of the or each gap in the insulating layer.

12. The display of claim 10 or claim 11 in which the conducting track extends around the or each gap such that a path for current is provided that does not pass over the gap.

13. The display of claim 12 in which the conductive track covers a larger area than the gap so that current may pass around the outside of the gap.

14. The display of claim 12 in which a bypass track is provided which branches off the track on one side of the or each gap and rejoins on a second side of the or each gap without passing over the or each gap.

15. A flexible display comprising:
a display arranged to change appearance on application of an electric field;
a plurality of display electrodes on a surface of the display shaped so as to define a plurality of display areas;
an insulating layer covering the display electrodes; and
a conducting track provided on the insulating layer;
in which a plurality of gaps are provided in the insulating layer, the conducting track contacts the electrodes through the gaps, with the conducting track comprising a plurality of segments each contacting one electrode and contacting each other at one or more junctions, and in which the or each junction is not over a gap.

16. The display of claim 15 in which each segment terminates at an electrode.

17. The display of claim 1 in which the display is a printed display.

18. The display of claim 1 in which the display is an electroluminescent display.

21. The display of claim 1 in which the display is a liquid crystal display.

22. An electronic device comprising the display of claim 1 and associated electronic circuits.
